(19) United States
(12) Patent Application Publication
(10) Pub. No.: US 2011/0013852 A1
(43) Pub. Date: Jan. 20, 2011

(54) APPROACH FOR DETERMINING MOTION VECTOR IN FRAME RATE UP CONVERSION

(75) Inventor: Ying-Ru CHEN, Tainan County (TW)

Correspondence Address: REN-SHENG INTERNATIONAL, 7F, NO. 57, SEC. 2, DUNHUA S. ROAD, TAIPEI, 106, TW

(73) Assignee: HIMAX TECHNOLOGIES LIMITED, Tainan County (TW)

(21) Appl. No.: 12/504,685

(22) Filed: Jul. 17, 2009

(51) Int. Cl. G06K 9/36

(52) U.S. Cl. 382/236

(57) ABSTRACT

One embodiment of the present invention sets forth a frame-up conversion method for preparing an interpolated frame. The method comprises (a) selecting a second block neighboring a first block within a first frame, (b) defining a first search window according to a second motion vector for the second block to identify a first matching block, (c) defining a second search window according to a location of the first matching block to identify a second matching block, (d) updating the first matching block to be the second matching block and updating the second search window and the second matching block or setting the second matching block as a target matching block based on whether the second matching block is the first matching block, (e) repeating (d) until the target matching block is set, determining the first motion vector by reference to the target matching block, and preparing the interpolated frame according to the first motion vector.

### BACKGROUND OF THE INVENTION

1. Field of the Invention

The present invention generally relates to video processing, and more particularly to an approach for determining a motion vector in frame rate up conversion.

2. Description of the Related Art

Unless otherwise indicated herein, the approaches described in this section are not prior art to the claims in this application and are not admitted to be prior art by inclusion in this section.

Frame rate conversion generally refers to a process of converting materials originated from one frame rate to a different frame rate. To support a high frame rate display, a frame rate up conversion (FRUC) may be necessary in order to convert a low frame rate video signal into high frame rate one. In FRUC, interpolated frames are generated using frames received at a low frame rate as the reference. Currently, the interpolation process may be performed based on the motion vectors of the received frames obtained through motion compensation schemes, so that moving objects within the interpolated frames may be correctly positioned. Although the motion-compensated FRUC offers some advantages, it also suffers artifacts when motion estimation is incorrect, especially when the received frames are complex or speedy.

For motion compensation in FRUC, an interpolated frame may be generated based on motion vectors for a plurality of blocks in a reference frame. One approach of obtaining a reliable motion vector for a specific block in the reference frame is to consider the motion vectors for the blocks neighboring the specific block. However, the motion vectors for the neighboring blocks may not be available, and considering the additional motion vectors increases computational complexity.

What is needed in the art is thus an approach that can determine motion vectors in an efficient manner to improve reliability of motion estimation and address at least the problems set forth above.

### SUMMARY OF THE INVENTION

One embodiment of the present invention describes a frame-up conversion method for preparing an interpolated frame. Specifically, the method comprises (a) selecting a second block neighboring a first block within a first frame, (b) defining a first search window according to a second motion vector for the second block to identify a first matching block, (c) defining a second search window according to a location of the first matching block to identify a second matching block, (d) updating the first matching block to be the second matching block and updating the second search window and the second matching block or setting the second matching block as a target matching block based on whether the second matching block is the first matching block, (e) repeating (d) until the target matching block is set, determining the first motion vector by reference to the target matching block, and preparing the interpolated frame according to the first motion vector.

At least one advantage of the present invention disclosed herein is the ability to reduce the computational complexity associated with determining the motion vector for a block.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a simplified block diagram showing an example video subsystem in a computing device according to one embodiment of the present invention;

FIG. 2A is a schematic diagram showing example relationships among a first frame, a second frame, and an interpolated frame and blocks in such frames in terms of time and locations;

FIG. 2B is a schematic diagram showing movement of an image from a first frame to a second frame;

FIG. 3A is a schematic diagram illustrating an example first frame having a set of blocks;

FIG. 3B is a schematic diagram showing a reference frame from which the motion vectors for the blocks corresponding to the neighboring blocks of a first block in a first frame may be selected;

FIG. 3C is a schematic diagram showing a process of selecting a matching block from a reference frame for a first block in a first frame, according to one embodiment of the present invention;

FIG. 4 is an example flow chart showing a process 400 for determining a motion vector for a video block, according to one embodiment of the present invention; and

FIG. 5 is a schematic diagram showing an example computer program product according to one embodiment of the present invention.

### DETAILED DESCRIPTION

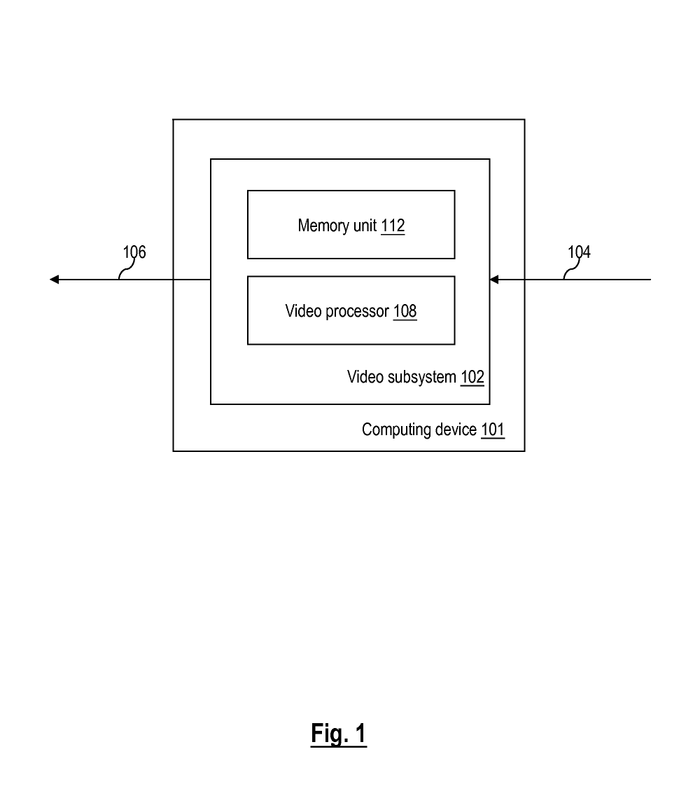

FIG. 1 is a simplified block diagram showing an example video subsystem 102 in a computing device 101 according to one embodiment of the present invention. The video subsystem 102 is configured to receive a sequence of incoming video frames 104, process the sequence of incoming video frames 104, and output a sequence of outgoing video frames 106. The video subsystem 102 includes a video processor 108 and a memory unit 112. The video processor 108 is configured to perform functions such as, without limitation, determining motion vectors for video frames and preparing one or more interpolated frames so that the interpolated frames to be outputted as a part of the outgoing video frames 106.

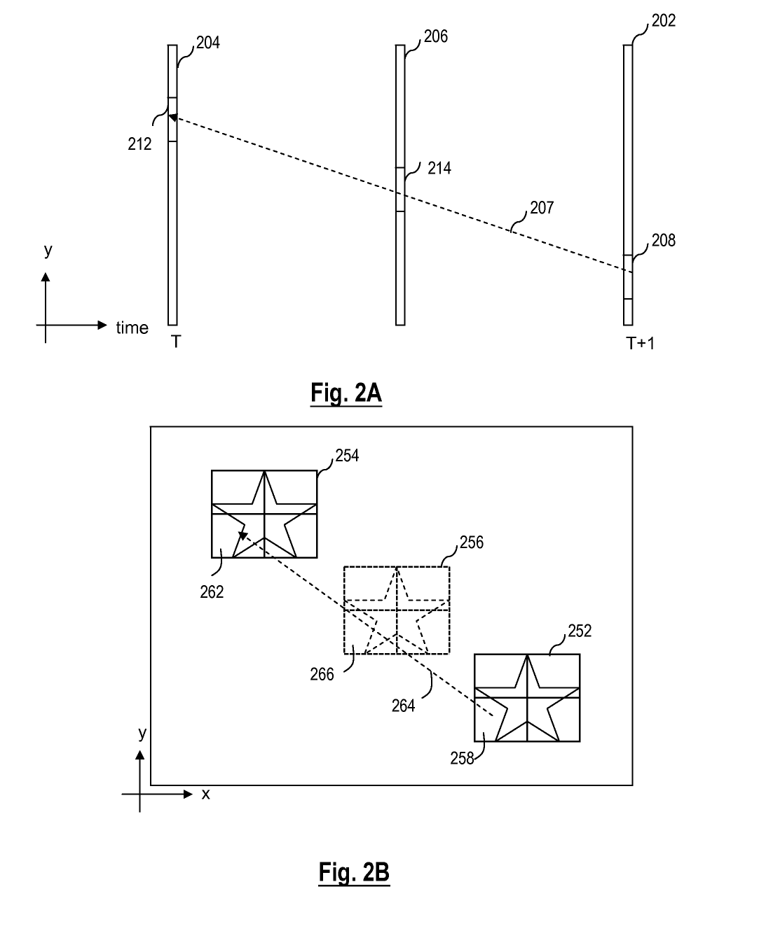

In conjunction with FIG. 1, FIG. 2A is a schematic diagram showing example relationships among a first frame, a second frame, and an interpolated frame and blocks in such frames in terms of time and locations. The first frame 202 and the second frame 204 could be a part of the incoming video frames 104. The interpolated frame 206 may be inserted between the first frame 202 and the second frame 204 before being outputted as a part of the outgoing video frames 106. In FIG. 2A, the second frame 204 refers to the video frame that is received by the video subsystem 102 prior to the first frame 202. For example, the second frame 204 may be received at time T, and the first frame 202 may be received and processed at time T+1. In the illustration shown in FIG. 2A, the second frame 204 may serve as a reference frame for the preparation of the interpolated frame 206. However, another video frame (not shown in FIG. 2A), which may be received at a different time than T, may server as the reference frame.

Each of the first frame 202 and the second frame 204 could be divided into a plurality of blocks. A block 208 is an example block in the first frame 202, and a block 212 is an example in the second frame 204. Processing of the first frame 202 includes determining a motion vector (e.g., motion vector 207) for the block 208. Suppose the block 212 corresponds to the block 208. The motion vector 207 for the block 208 may help to identify an interpolated block 214 in the interpolated frame 206. Thus, with the motion vectors for the blocks in the first frame 202, the corresponding blocks in the interpolated frame 206 may be determined as the result.

FIG. 2B is a schematic diagram showing movement of an image from a first frame 252 to a second frame 254. An interpolated frame 256 is prepared on the basis of the first frame 252 and the second frame 254. In one implementation, the motion vectors for the blocks in the first frame 252 may be utilized to prepare the interpolated frame 256. Specifically, the first frame 252 may include one or more blocks such as a block 258, which corresponds to a block 262 in the second frame 254. With a motion vector 264 for the block 258, an interpolated block 266 in the interpolated frame 256 may be prepared on the basis of the location of the block 258 and the motion vector 264.

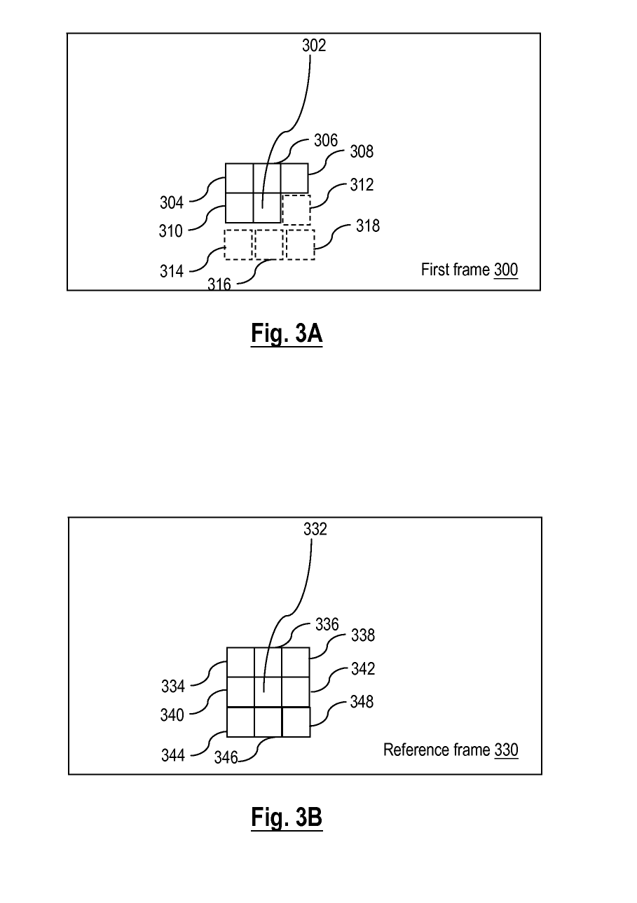

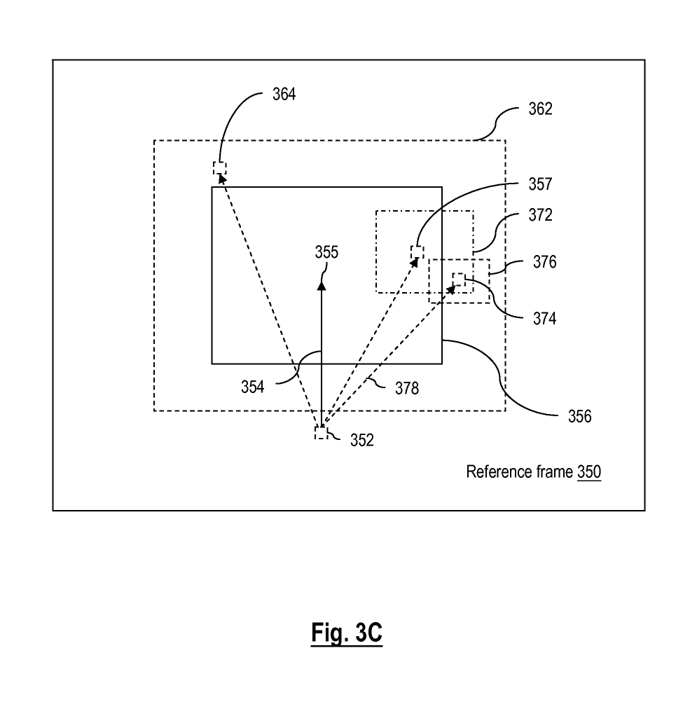

FIG. 3A is a schematic diagram illustrating an example first frame 300 having a set of blocks. In addition to a first block 302, the first frame 300 may include blocks neighboring the first block 302, such as blocks 304, 306, 308, 310, 312, 314, 316, and 318. Due to the proximity between the first block 302 and its neighboring blocks, they may represent the same portion of a video frame. One approach to determine a motion vector for the first block 302 is to start with a motion vector for one of the neighboring blocks as a candidate motion vector for the first block 302.

Depending on the content of the first block 302, certain blocks neighboring the first block 302 may be relied upon in the motion vector determination process. In one implementation, when the content of the first block 302 indicates that the first block 302 is in a texture region, the candidate motion vector for the first block 302 may be selected from the motion vectors for the eight neighboring blocks 304, 306, 308, 310, 312, 314, 316, and 318. On the other hand, when the content of the first block 302 shows that the first block 302 is in a smooth region, the candidate motion vector for the first block 302 may be selected instead from the motion vectors for the four neighboring blocks 306, 310, 312, and 316, since the image in the smooth region may be easier to identify than the image in the texture region. In addition, the candidate motion vector may refer to the motion vector for the most reliable neighboring block among the set of the neighboring blocks. In one implementation, the most reliable neighboring block is the block among the set of the neighboring blocks having the smallest difference (e.g., sum absolute difference) with its matching block.

In one implementation, the motion vectors for the neighboring blocks are determined in a specific sequence. The sequence may start from the block located at the upper-left corner of the first frame 300, proceed to the next blocks in the same row, move to the blocks in the next row, and end at the block at the lower-right corner of the first frame 300. With such a sequence, when the motion vector for the first block 302 is to be determined, the motion vectors for the blocks 304, 306, 308, and 310 may have already been determined, but the motion vectors for the blocks 312, 314, 316, and 320 may not have been. When the motion vectors for the blocks are not available to be utilized to determine the motion vector for the first block 302, in one implementation, the motion vectors for the corresponding blocks in a reference frame (e.g., the second frame 204 in FIG. 2A) may be utilized instead. Here, the motion vectors for the blocks in the reference frame corresponding to the blocks 312, 314, 316, and 318, have already been determined and are available.

More specifically, in conjunction with FIG. 3A, FIG. 3B is a schematic diagram showing a reference frame 330 from which the motion vectors for the blocks corresponding to the neighboring blocks of the first block 302 may be selected. The reference frame 330 includes a plurality of blocks 332, 334, 336, 338, 340, 342, 344, 346, and 348. They correspond to blocks 302, 304, 306, 308, 310, 312, 314, 316, and 318 in the first frame 300, respectively. Suppose by the time the first frame 300 is being processed, the motion vectors for the blocks in the reference frame 332 have already been determined and are available. When the motion vector for a block (e.g., the block 312) neighboring the first block 302 is not available during a motion vector estimation process for the first block 302, the motion vector for a block in the reference frame 330 (e.g., the block 342) corresponding to the neighboring block 312 may serve as the motion vector for the neighboring block 312. Then the candidate motion vector for the first block 302 may be selected from the motion vectors for the set of the corresponding blocks in the reference frame 330.

In conjunction with FIG. 3A, FIG. 3C is a schematic diagram showing a process of selecting a matching block from a reference frame for the first block 302, according to one embodiment of the present invention. In one implementation, the matching block may be utilized to determine the motion vector for the first block 302 and the location and the motion vector for an interpolated block in an interpolated frame. The reference frame 350 may include a plurality of blocks such as a corresponding block 352. The corresponding block 352 broadly refers to a block that corresponds to the first block 302 of the first frame 300 in FIG. 3A. When a candidate motion vector 354 is selected for the first block 302, a first reference location 355 could be obtained on the basis of the candidate motion vector 354 and the location of the corresponding block 352.

With the first reference location 355, a first search window 356 within the reference frame 350 may be defined. Blocks that are within the first search window 356 may be processed to identify a first matching block 357. One example block matching process is to calculate a first difference (e.g., sum absolute difference) between each block within the first search window 356 and the first block 302. The block in the first search window 356 that is associated with a large first difference is indicative of a large difference with the first block 302 and thus may be less likely to be identified as the first matching block 357. On the other hand, in one implementation, the block in the first search window 356 that is associated with the smallest first difference within such a window may be identified as the first matching block 357.

The block matching process may further include calculating a second difference. One example second difference is a difference in direction between the motion vector 354 and each of the motion vectors for the blocks in the first search window 356. If the motion vector for a particular block in the first search window points to the same or substantially similar direction as the motion vector 354, then the particular block may be more likely to be identified as the first matching block 357. Another example second difference is a difference in length between the motion vector 354 and each of the motion vectors for the blocks in the first search window 356. If the motion vector for a particular block in the first search window 356 is similar in length as the motion vector 354, then the particular block may be more likely to be identified as the first matching block 357.

The various types of differences discussed in the previous paragraphs are some examples to illustrate some embodiments of the present invention. They may correspond to predetermined values, and these values may be added or subject to other mathematical operations to provide a basis for identifying the first matching block 357.

To ensure the reliability of the first matching block 357, additional search windows may be defined, such as a second search window search 372. The second search window 372 may also include a plurality of blocks. The second search window 372 is defined on the basis of the first matching block 357, and a second matching block 374 may be identified within the second search window 372 through the similar processes for identifying the first matching block 357 in the first search window 356. In other words, the second matching block 374 may be identified on the basis of the SAD between each of the blocks within the second search window 372 and the first block 302 and/or the difference between the direction and/or length between each of the motion vectors for the blocks in the second search window 372 and the motion vector 354.

When the second matching block 374 is not the first matching block 357, as shown in FIG. 3C, another search window (e.g., a third search window 376) on the basis of the second matching block 374 may be defined. A third matching block may be identified within the third search window 376 through the similar block matching processes discussed above. When the third matching block is the same as the second matching block 374, then this second matching block 374 becomes the target matching block. Here, a motion vector 378 between the target matching block and the corresponding block 352 is determined to be the motion vector for the first block 302. This process of defining a search window and locating a matching block within the defined search window may continue iteratively until the N^{th} matching block in the N^{th} search window is the same as the (N-1)^{th} matching block in the (N-1)^{th} search window, where N is a positive integer.

On the other hand, if the second matching block 374 is the same as the first matching block 357, then no more search windows is defined. The second matching block 374 becomes the target matching block for the first block 302. A motion vector established between this target matching block and the corresponding block 352 is then determined to be the motion vector for the first block 302.

In some situations, the first matching block 357, though identified, may still fail certain predetermined criteria (e.g., exceeding a predetermined difference threshold). In one implementation, when the first matching block 357 fails the predetermined criteria, the first search window 356 is enlarged, so that an extended search window 362 may be defined. The extended search window 362 is defined on the basis of the first reference location 355. A different matching block 364, which satisfies the predetermined criteria, may be located within the extended search window 362. This matching block 364 may be determined on the basis of the difference between each of the blocks in the extended search window 362 and the first block 302, and/or the difference between each of the motion vectors for the blocks in the extended search window 362 and the motion vector 354, where at least one of the differences is lower than the predetermined difference threshold.

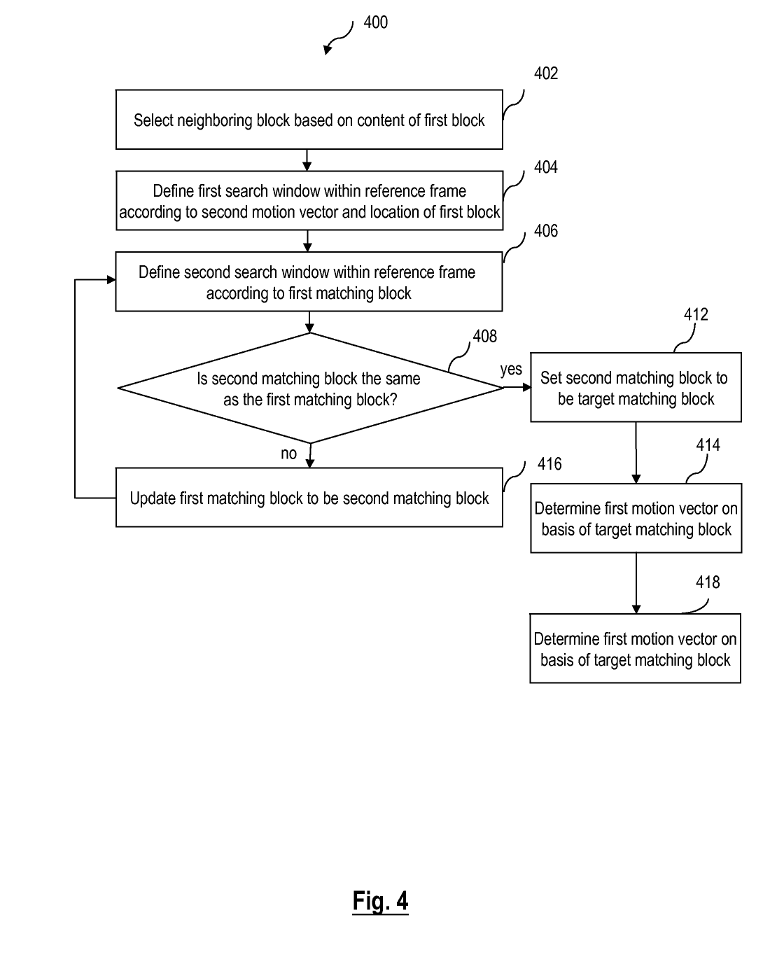

FIG. 4 is an example flow chart showing a process 400 for determining a first motion vector for a first block, according to one embodiment of the present invention. In operation 402, the process 400 selects a second block neighboring the first block based on the content of the first block, wherein the second block may correspond to a second motion vector. In operation 404, the process 400 defines a first search window within a reference frame according to the second motion vector and a location of the first block. In doing so, the process 400 may identify a first matching block in the first search window. The first matching block may satisfy certain predetermined criteria. In operation 406, the process 400 further defines a second search window on basis of the first matching block within the reference frame. The process 400 may determine a second matching block within the second search window. In operation 408, the process 400 determines whether the second matching block is the first matching block. If so, the process 400 sets the second matching block to be a target matching block in operation 412. In operation 414, the process 400 may determine the first motion vector based on the target matching block. More specifically, the process 400 may determine the motion vector between the target matching block and a block in the reference frame that corresponds to the first block as the first motion vector.

In operation 416, the process 400 updates the first matching block to be the second matching block. In other words, using this updating mechanism, the process 400 may be able to iteratively define search windows to identify a desired matching block. The iteration may continue until the matching block identified in N^{th} defined search window is the same as the matching block identified in the immediately preceding, (N-1)^{th}, defined search window.

In some implementations, after having determined the first motion vector in operation 414, the process 400 may continue to evaluate this determined first motion vector. For example, since the second motion vector utilized in the process 400 may be from the reference frame, the process 400 may further fine tune the first motion vector determined in operation 414 by ensuring that the second motion vector is from the first frame in operation 418. In other words, the process 400 may be repeated by utilizing the second motion vector from the first frame, as opposed to the reference frame, to define the first search window and search for the first motion vector.

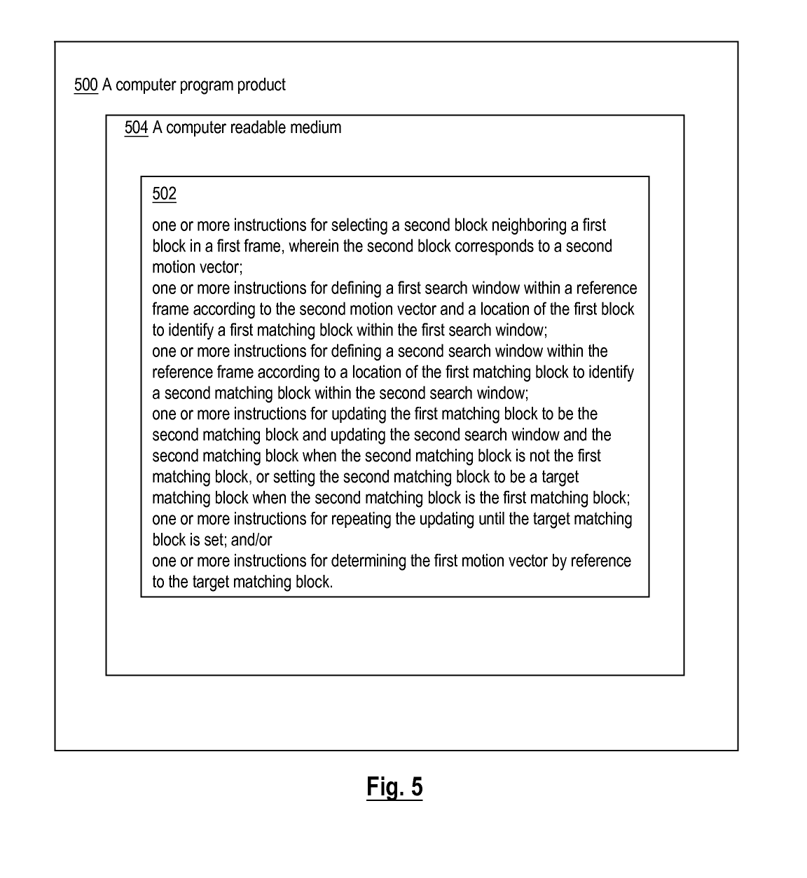

FIG. 5 is a schematic diagram showing an example computer program product 500 according to one embodiment of the present invention. Computer program product 500 includes one or more sets of instructions 502 for executing the motion estimation method according to one embodiment of the present invention. For illustration only, the instructions 502 may reflect the process described above and illustrated in FIG. 4. Computer program product 500 may be recorded in a computer readable medium 504. According to one embodiment of the present invention, the computer program product 500 may be configured to be executed in a video subsystem of a computing device. Illustrative computer readable media include, but are not limited to: (i) non-writable storage media (e.g., read-only memory devices within a computer such as CD-ROM disks readable by a CD-ROM drive, ROM chips, or any type of solid-state non-volatile semiconductor memory) on which information is permanently stored; and (ii) writable storage media (e.g., floppy disks within a diskette drive, CD-RW disks, DVD-RW disks, flash memory, hard-disk drive, or any type of solid-state random-access semiconductor memory) on which alterable information is stored.

The above examples, embodiments, instruction semantics, and drawings should not be deemed to be the only embodiments, and are presented to illustrate the flexibility and advantages of the present invention as defined by the following claims.

I claim:

1. A motion estimation method for determining a first motion vector for a first block within a first frame, comprising:
(a) selecting a second block neighboring the first block, wherein the second block corresponds to a second motion vector;
(b) defining a first search window within a reference frame according to the second motion vector and a location of the first block to identify a first matching block within the first search window;
(c) defining a second search window within the reference frame according to a location of the first matching block to identify a second matching block within the second search window;
(d) updating the first matching block to be the second matching block and going back to step (c) to update the second search window and the second matching block when the second matching block is not the first matching block, or setting the second matching block to be a target matching block when the second matching block is the first matching block;
(e) repeating step (d) until the target matching block is set; and
(f) determining the first motion vector by reference to the target matching block.

2. The motion estimation method of claim 1, wherein the selecting comprises selecting the second block from a set of blocks neighboring the first block, wherein the set of blocks is determined by a content of the first block.

3. The motion estimation method of claim 2, wherein the set of blocks is from the first frame.

4. The motion estimation method of claim 2, wherein the set of blocks is from both the first frame and the reference frame.

5. The motion estimation method of claim 2, further comprising updating the first motion vector after the motion vectors for the set of blocks neighboring the first block have been determined.

6. The motion estimation method of claim 2, wherein the second block is the most reliable among the set of blocks.

7. The motion estimation method of claim 1, wherein the reference frame precedes the first frame.

8. The motion estimation method of claim 1, further comprising enlarging the first search window if the first matching block fails to meet a first predetermined threshold.

9. A frame-up conversion method for preparing an interpolated frame, comprising:
(a) selecting a second block neighboring a first block, wherein the second block corresponds to a second motion vector and the second block and the first block are in a first frame;
(b) defining a first search window within a reference frame according to the second motion vector and a location of the first block to identify a first matching block within the first search window;
(c) defining a second search window within the reference frame according to a location of the first matching block to identify a second matching block within the second search window;
(d) updating the first matching block to be the second matching block and going back to step (c) to update the second search window and the second matching block when the second matching block is not the first matching block, or setting the second matching block to be a target matching block when the second matching block is the first matching block;
(e) repeating step (d) until the target matching block is set;
(f) determining a first motion vector by reference to the target matching block; and
(g) preparing the interpolated frame based on the first motion vector.

10. The frame-up conversion method of claim 9, wherein the selecting comprises selecting the second block from a set of blocks neighboring the first block, wherein the set of blocks is determined by a content of the first block.

11. The frame-up conversion method of claim 10, wherein the set of blocks is from the first frame.

12. The frame-up conversion method of claim 10, wherein the set of blocks is from both the first frame and the reference frame.

13. The frame-up conversion method of claim 10, further comprising updating the first motion vector after the motion vectors for the set of blocks neighboring the first block have been determined.

14. The frame-up conversion method of claim 10, wherein the second block is the most reliable among the set of blocks.

15. The frame-up conversion method of claim 9, wherein the reference frame precedes the first frame.

16. The frame-up conversion method of claim 9, further comprising enlarging the first search window if the first matching block fails to meet a first predetermined threshold.

17. A computer readable medium containing a sequence of instructions for determining a first motion vector for a first block within a first frame, wherein the sequence of instructions when executed by a processing unit, causes the processing unit to:
(a) select a second block neighboring the first block, wherein the second block corresponds to a second motion vector;
(b) define a first search window within a reference frame according to the second motion vector and a location of the first block to identify a first matching block within the first search window;
(c) define a second search window within the reference frame according to a location of the first matching block to identify a second matching block within the second search window;
(d) update the first matching block to be the second matching block and go back to step (c) to update the second search window and the second matching block when the second matching block is not the first matching block, or set the second matching block to be a target matching block when the second matching block is the first matching block;
(e) repeat step (d) until the target matching block is set; and
(f) determine the first motion vector by reference to the target matching block.

18. The computer readable medium of claim 17, further comprising a sequence of instructions when executed by the processing unit, causes the processing unit to select the second block from a set of blocks neighboring the first block, wherein the set of blocks is determined by a content of the first block.

19. The computing readable medium of claim 17, further comprising a sequence of instructions when executed by the processing unit, causes the processing unit to update the first motion vector after determining the motion vectors for the set of blocks neighboring the first block.

20. The computing readable medium of claim 17, further comprising a sequence of instructions when executed by the processing unit, causes the processing unit to enlarge the first search window if the first matching block fails to meet a first predetermined threshold.
